(19) United States
(12) Patent Application Publication
(10) Pub. No.: US 2014/0095282 A1
(43) Pub. Date: Apr. 3, 2014

(54) Methods and Apparatus for Advertising and Sale Promotion

(71) Applicant: Liron Slonimsky, (US)

(72) Inventors: Liron Slonimsky, Tel Aviv (IL); Micha Breakstone, Ra'anana (IL)

(21) Appl. No.: 13/944,896

(22) Filed: Jul. 18, 2013

Related U.S. Application Data
(63) Continuation of application No. 13/918,967, filed on Jun. 16, 2013.
(60) Provisional application No. 61/708,016, filed on Sep. 30, 2012.

(51) Int. Cl. G06Q 30/02

(52) U.S. Cl. CPC G06Q 30/0261
USPC 705/14.16; 705/14.58; 705/14.19

(57) ABSTRACT

A method for advertising and sales comprising: a first electronic device which is carried by an ad agent, wherein said first electronic device contains a list of ad products used by said ad agent and wherein when first electronic device inquired by a second electronic device which is carried by a potential buyer that is located within proximity to said ad agent, first electronic device provides information about said ad products to said second electronic device. The method further comprises servers which receive and store information on the inquiries performed to between said first and second electronic devices and enables on-line purchasing of the ad products. Ad products are typically consumer products including shoes, clothes, bags, apparel, watches, glasses, luggage cases, accessories, mp3 players, cellular phones, tablets and laptops.

### RELATED APPLICATION

This application claims priority to and the benefit of U.S. provisional patent application Ser. No. 61/708,016 filed Sep. 30, 2012, which is incorporated herein by reference in its entirety.

### FIELD AND BACKGROUND OF THE INVENTION

The following description is provided to assist the understanding of the reader. None of the information provided or references cited is admitted to be prior art.

The present invention, in some embodiments thereof, relates to advertising and sale promotion and more particularly, but not exclusively, to consumer product advertising and sale promotion.

Consumer products advertising and sale promotion is carried through many channels: (1) traditional advertising: newspapers, magazines and other print media; (2) ads in public areas and retail environment using signs, posters and products samples; (3) electronic media such as radio and TV; (4) internet related media, such as entails, web pages, coupons sites, social networks like Facebook and, recently also ads pushed in to our smart phones in various ways.

More and more advertising is specifically targeted and integrated in to information technology systems and the internet. U.S. patent application Ser. No. 11/977,045 (Monfried et al.) demonstrates targeted advertisement based on that user's activities in the network. U.S. patent application Ser. No. 12/505,734 (Chakraborty et al.) demonstrates advertising in mobile devices. U.S. patent application Ser. No. 10/997,121 (Morgenstern et at) teaches internet advertising based on social networking and word of mouth. Similarly U.S. patent application Ser. No. 12/871,416 (Gopinath et al.) teaches internet advertising based on user activities history and user preference.

In some cases nowadays, products are embedded with digital information using devices such as RFID. Those devices, sometimes referred to as smart tags, are using various types of passive and active short range communication and can transmit various types of information, including advertising and sales promotion related information. For instance, U.S. patent application Ser. No. 13/430,621 (Morton et al), U.S. patent application Ser. No. 12/022,661 (Moritz et al.), U.S. patent application Ser. No. 11/252,722 (Kitada) and U.S. patent application Ser. No. 12/887,228 (Morton et al.) are several examples for such usage.

Consumer products, such as shoes, clothes, bags and accessories are fashion products whose sale promotion is partially performed independently by consumers who wear or use those products without any control and awareness of advertisers. The present invention addresses particularly, but not exclusively, this segment of the advertising market.

The present invention is centered on “seen in use” promotion and allows, product manufacturers, chain of sale, advertisers, customers as well as potential new customers to participate and benefit from this direct |seen in use” sale promotion process.

### SUMMARY OF THE INVENTION

The present invention is advertising and sales method, system, electronic device and software applied to consumer products.

According to an aspect of some embodiments of the present invention there is provided a method for advertising and sales comprising: a first electronic device which is carried by an ad agent, wherein the first electronic device contains a list of ad products used by the ad agent and wherein when first electronic device inquired by a second electronic device which is carried by a potential buyer that is located within proximity to the ad agent, first electronic device provides information about the ad to products to the second electronic device.

According to some embodiments of the invention, the ad products are consumer products including but not limited to shoes, clothes, bags, apparel, jackets, watches, glasses, purses, luggage cases, accessories, electric gadgets, mp3 players, cellular phones, tablets, laptops or any other commercial products used by the ad agent.

According to some embodiments of the invention, the first electronic device and the second electronic device are off-the-shelf smart phones comprising an add-on application to manage the list of ad products and perform and process the inquiries.

According to some embodiments of the invention, the ad products comprise smart tags which communicate with the first electronic device.

According to some embodiments of the invention, the communication protocol between the smart tags and the first electronic devices is RFID or Bluetooth or ZigBee or NFC or WiFi or any other short range communication protocol.

According to some embodiments of the invention, the first electronic device and the second electronic device are communicating with a server reside on a network.

According to some embodiments of the invention, the communication protocol between the first and second electronic devices and the servers is Wi-Fi or 3G or LTE or any other communication protocol that is used to connect mobile devices to the internet.

According to some embodiments of the invention, the server comprises plurality of servers.

According to some embodiments of the invention, the server receives and stores information on the inquiries and responses of the first and second electronic devices.

According to some embodiments of the invention, the server receives on-line purchasing requests of the ad products from the second electronic devices.

According to some embodiments of the invention, the inquiry is performed using Wi-Fi, Bluetooth, RFID, ZigBee, NFC or any other short range communication protocol.

According to some embodiments of the invention, the server receives the to location information of the first and second electronic devices.

According to some embodiments of the invention, The method of claim 12, wherein the inquiry transaction between first and second electronic devices is performed indirectly using mediation by the server.

According to some embodiments of the invention, the inquiries information stored by the server is further processed to detect fake products, frauds and other illegal acts or sales of ad products.

According to some embodiments of the invention, the ad agent receives commissions for sale transactions related to responses to inquiries of ad products used by the ad agent.

According to some embodiments of the invention, the ad agents and the potential buyers receive discounts, commissions and other benefits, for performing the inquires and providing the responses.

According to an aspect of some embodiments of the present invention there is provided an advertising and sales system comprising: plurality of ad terminals carried by ad agents, wherein ad agents are persons wearing, carrying or using ad products; plurality of ad terminals carried by potential buyers, wherein potential buyers are persons who sees ad products worn, carried or used by the ad agents and interested on buying the ad products; and one or more servers; wherein said ad terminals that are carried by potential buyers are configured to inquire said ad terminals which is carried by ad agents and are located within proximity of said potential buyers, and wherein said ad terminals that are carried by ad agents are configured to respond to said inquiries with a list of ad products worn, carried or used by said ad agents, and wherein said server records information on said inquires and responses and provide purchasing services for said ad products on said list.

According to some embodiments of the invention, the ad terminals are off-the-shelf smart phones comprise an add-on application.

According to some embodiments of the invention, the ad products comprise smart tags which communicate with the ad terminals.

According to some embodiments of the invention, the inquiry is performed directly between ad terminals carried by potential buyers and the smart tags.

According to some embodiments of the invention, the inquiries and responses information recorded by the server is further processed to detect fake products, frauds and other illegal acts or sales of ad products.

According to an aspect of some embodiments of the present invention there is provided an electronic device for product advertisement comprising: a storage containing a list of ad products worn, carried or used by an ad agent who carries the electronic device; a communication means configured to receive inquiries and to send responses on the ad product list; a processor to process the inquiries and compose the responses; wherein the inquiries is initiated by potential ad product buyers who sees the ad products in use and the response contains an advertising information to promote the ad product purchasing.

According to an aspect of some embodiments of the present invention there is provided a software application for mobile electronic device comprising: a wardrobe, wherein a wardrobe is a list of ad products ad agent has possession of; an outfit, wherein an outfit is a list of ad products from the wardrobe ad agent instantaneously caring on; an inquiry service that enables a user who is a potential buyer to inquire for ad products in the outfits in proximity to the user; an response service that respond to the inquiries with ad information on the outfit.

According to some embodiments of the invention, the mobile electronic device is a smartphone.

According to some embodiments of the invention, the software further comprises service that enable online purchasing of ad products appears in the response to said inquiry.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For, example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a controller, such as a computing platform for executing a plurality of instructions. Optionally, the data processor includes a volatile memory for storing instructions and/or data and/or a non-volatile storage, for example, a solid state hard-disk and/or removable media, for storing instructions and/or data. Optionally, a network connection is provided as well. A display and/or a user input device such as a keyboard or touch screen are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a system block diagram, in accordance with a preferred embodiment of the invention;

FIG. 2 is a software modules block diagram of an exemplary software, in accordance with a preferred embodiment of the invention;

FIG. 3 is a screenshot illustrating the main screen of an exemplary software, in accordance with a preferred embodiment of the invention;

FIG. 4 is a screenshot illustrating the more information screen of an exemplary software, in accordance with a preferred embodiment of the invention;

FIG. 5 is an inquiry process flowchart of an exemplary software, in accordance with a preferred embodiment of the invention;

FIG. 6 is a screenshot illustrating the ‘near by stores’ screen of an exemplary software, in accordance with a preferred embodiment of the invention;

FIG. 7 is a screenshot illustrating the ‘buy product online’ screen of an exemplary software, in accordance with a preferred embodiment of the invention;

FIG. 8 is a buy online process flowchart of an exemplary software, in accordance with a preferred embodiment of the invention;

FIG. 9 is a screenshot illustrating the ‘similar product’ screen of an exemplary software, in accordance with a preferred embodiment of the invention;

FIG. 10 is a screenshot illustrating the ‘wishlist’ screen of an exemplary software, in accordance with a preferred embodiment of the invention;

FIG. 11 is a screenshot illustrating the ‘wardrobe’ screen of an exemplary software, in accordance with a preferred embodiment of the invention;

FIG. 12 is a screenshot illustrating the ‘outfit’ screen of an exemplary software, in accordance with a preferred embodiment of the invention;

FIG. 13 is an adding a product to the wardrobe process flowchart of an exemplary software, in accordance with a preferred embodiment of the invention;

FIG. 14 is a an adding a product to the outfit process of an exemplary software, in accordance with a preferred embodiment of the invention;

FIG. 15 is a screenshot illustrating the ‘catalog’ screen of an exemplary software, in accordance with a preferred embodiment of the invention;

FIG. 16 is a screenshot illustrating the alternative ‘catalog’ screen of an exemplary software, in accordance with a preferred embodiment of the invention;

FIG. 17 is a screenshot illustrating the ‘profile’ screen of an exemplary software, in accordance with a preferred embodiment of the invention;

FIG. 18 is a screenshot illustrating the ‘Inquires/Commissions status’ screen of an exemplary software, in accordance with a preferred embodiment of the invention;

FIG. 19 is a block diagram of computing system, in accordance with a preferred embodiment of the invention; and

FIG. 20 is a block diagram of the back office, in accordance with a preferred embodiment of the invention.

### DESCRIPTION OF SPECIFIC EMBODIMENTS OF THE INVENTION

The present invention, in some embodiments thereof, relates to advertising and sale promotion and more particularly, but not exclusively, to consumer product advertising and sale promotion. Consumer products, such as but not limited to shoes, clothes, bags and accessories are fashion products which are promoted independently and without any control of the advertisers by the consumers who wear or use those products. Word of mouth as well as being seen in use by other potential consumers plays an important role in buying decisions of such products. Style and fashion products also comprise electric gadgets, such as but not limited to cellular phones, mp3 players, tablets, laptops, watches, cars, jewelry, glasses, purses, hobbies equipments, etc. In some cases this products are highly branded and sold in premium prices. The present invention addresses particularly, but not exclusively, this segment of the advertising market which is characterized by “seen the product in use” by potential new customers. In many cases the product users are opinion leaders, such as celebrities, popular kids in class or even the boss.

The core of the invention is to provide a way to promote, manage and track the “seen the product in use” promotion transactions.

As used herein, the term “ad agent” means a consumer that uses a product and has the ability to advertise and promote sale of this products in accordance with the present invention. “seen the product in use” means that a potential buyer saw the product in use with his own eyes in the real world rather then seeing it on an advertisement in a poster, journal, TV, web page or any other advertising channel. The term “in use” means worn, carried, driven, played or any other action the ad agent performs on the product.

As used herein, the term “ad product” means any product an ad agent is using and can be advertised or promoted in accordance with the present invention.

To be able to advertise ad product, the ad agent carries with him an electronic device, typically his cellular phone or smart phone that maintains a list of ad products currently in use.

As used herein, the term “ad terminal” means any electronic device, e.g., computing device or data processing apparatus, which is carried by an ad agent, maintains his ad product list and provides additional services in accordance with the present invention. Ad terminal can be implemented as an application of a smart phone, such as but not limited to iPhone or Android smart phones. In this case, the HW facilities that are needed for the ad terminal, such as but not limited to short range communication, RFID reader and barcode scanner, already exist in customers hands while only the dedicated software should be added.

The ad product list can be automatically assembled by short range communication between ad product and ad terminal whenever ad product comprises RFID or any other smart tags. Smart tags are devices that store the product information and communicate this information to the ad terminal. Optionally or alternatively, the ad product list can be updated by reading a bar code or a QR code printed on the ad products. Optionally or alternatively, the list can be updated by the ad agent manually by searching the product in a catalog. The ad product information contains manufacturer name, model ID, size, color and any other attribute that identifies the ad product type. A URL or any other reference can be transmitted by the ad product smart tag enabling the ad terminal to retrieve full details of the ad product.

When a potential buyer sees the ad product in use by an ad agent she may want to inquire details about the ad product, such as, the manufacturer name, the product price, the place of purchase, etc. Typically today, this is done by asking the person who uses the product. Such an act may be considered impolite. Furthermore, the interrogated person might not cooperate or not know the full details. The interrogating person might avoid asking questions being too shy or feeling that it is improper. In all those cases an excellent sale promotion opportunity is missed. The current invention provide both to the act agent and to the potential buyer the ability to perform this transaction easily, quickly, conveniently and privately with additional benefits that will be described later on.

As used herein, the term “potential buyer” means a consumer that has the ability to inquire for ad products and buy them in accordance with the present invention.

In order for a potential buyer to inquire ad products, the potential buyer should have an ad terminal. When the potential buyer sees a product she likes, she uses her ad terminal to inquire for the specific product she wants. The ad terminal is communicating with other ad terminals in its surroundings. If another ad terminal has ad products that match the description in its own ad product list, it transfers the information of that ad product to the ad terminal of the potential buyer. The potential buyer can see the details of the desired ad product in her device and further processes the inquiry. Further processing includes but is not limited to getting more details on the product, seeing where the product can be bought and what the product price is, performing online buying, etc. The ad agent who promotes the buying transaction is recorded and optionally gets credit for fulfilling the inquiry and promoting the sale.

Ad terminals are connected to the internet and can perform a variety of transactions with servers in the network, collectively referred as the back-office. The transactions may include, retrieving information on ad products, retrieving information to on prices and promotion, performing online sale transaction, etc. The back-office servers may be operated by a variety of entities, including, but not limited to, ad product manufacturers, advertising agencies, entities in the sale chain like distributors, retails and wholesalers, and ad terminals developers and operators.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### EXAMPLES

Reference is now made to the following examples, which together with the above descriptions illustrate some embodiments of the invention in a non limiting fashion.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

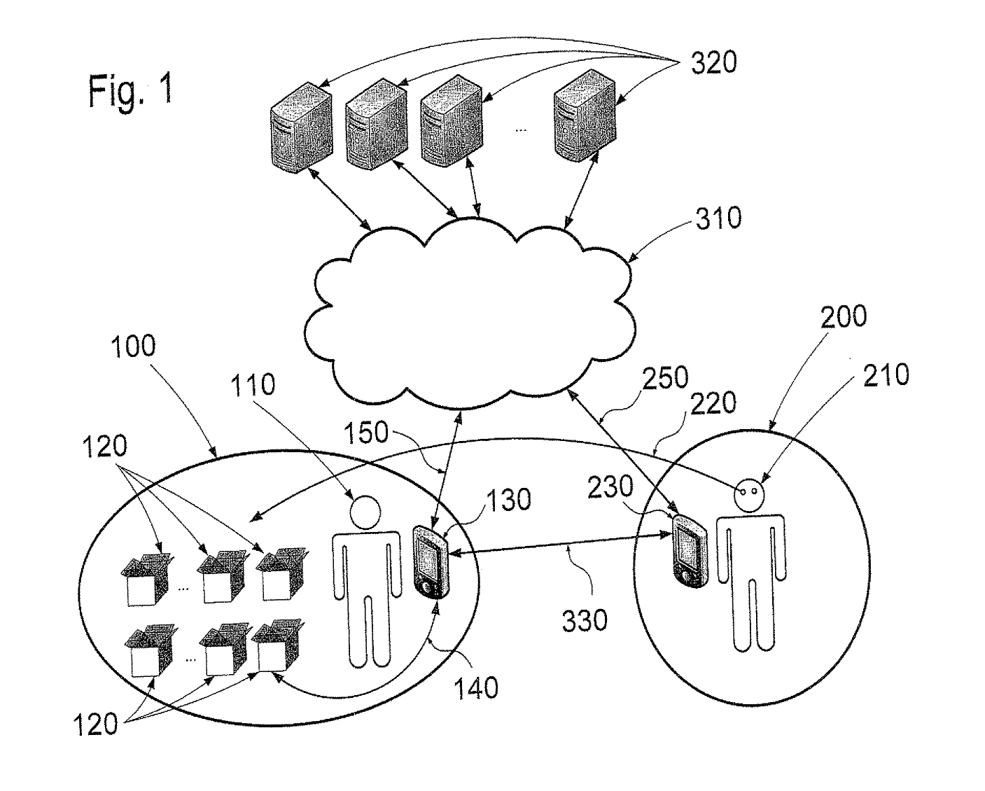

For purposes of better understanding some embodiments of the present invention, reference is first made to FIG. 1. FIG. 1 illustrates a system block diagram in according to a preferred embodiment of the invention. Ad agent 110 is any person that has one or more products, ad product 120, he wishes to advertise. Ad product 120 may be any product ad agent 110 is using including, but not limited to, shoes, boots, hats, clothes, apparel, jackets, coats, bags, such as but not limited to, handbags, purses, evening-bags, luggage cases, jewelry, watches, glasses, accessories, electric gadgets, such as but not limited to cellular phones, mp3 players, tablets, laptops, etc.

To facilitate advertising of ad products 120, ad agent 110 carries ad terminal 130. Ad terminal 130 maintains a list of ad products 120 that are currently used by ad agent 110. The ad product list in ad terminal 130 is build using three options: (a) Manuel insertion of ad product by ad agent; (b) by barcode or QR code scanning using ad terminal 130; and (c) automatic insertion by ad terminal 130 via peer to peer short range communication 140 between ad terminal 130 and ad products 120 smart tag.

Peer to peer short range communication 140 may includes but is not limited to RFID communication protocol, Bluetooth, ZigBee, NEC communication, Infrared Data Association (“IRDA”), Ad hoc WiFi, Wi-Fi, Local Area Networks (“LAN”) or any other short range communication.

As user herein, the term “smart tag” means a tag that is attached to ad product 120 and comprises short range communication 140 and information storage. The term “compliant” smart tag means any smart tag that is attached to ad product 120 that can communicate with ad terminal 130 and transmit product information in an appropriate format in accordance with the current invention.

Single advertising unit 100 contains a triplet of ad agent 110, ad products 120 and ad terminal 130. In typical scenario, plurality of advertising elements 100 coexists together. For the sake of clarity, in FIG. 1 only single advertising element 100 is presented.

Advertising element 100 goal is to advertise ad products 120 to potential buyers. A potential buyer element 200 in accordance with the current invention comprises a potential buyer 210, i.e., any person, with an ad terminal 230. When potential buyer 210 is in proximity to ad agent 110, potential buyer 210 can see (illustrated in FIG. 1 by link 220) ad products 120 worn, carried or used in any other way by ad agent 110. When potential buyer 210 is interested on ad products 120, potential buyer 210 may inquire for ad products 120 using his ad terminal 230.

The inquiry message transferred from ad terminal 230 to ad terminal 130 via another short range pear to pear communication mean 330. Peer to peer short range communication 330 may includes but is not limited to RFID communication protocol, Bluetooth, ZigBee, NFC communication, Infrared Data Association (“IRDA”), Ad hoc WiFi, Wi-Fi, Local Area Networks (“LAN”) or any other short range communication.

The inquiry can be a non specific or a specific inquiry. If a non specific inquiry is performed, a list of all ad products 120 gathered from all ad terminals 130 in the surrounding of ad terminal 230 is provided to potential buyer 210. If a specific query is performed, for example categorized to only shoes, only ad products 120 categorized to as shoes will be presented to potential buyer 210. The list may contain a picture of the product so potential buyer 210 can verify that the product is identical to the one she is looking for. If potential buyer 210 selects a product from the list, further information is provided to potential buyer 210. This information may contain additional details on the selected ad products 120. This information may come from a server 320 connected with ad terminal 230 through a network 310, e.g., the interne.

As used herein, the term server means any computing device including, but is not limited to, mainframe computer, mid range computer, work station, personal computer, etc.

Both ad terminal 130 and ad terminal 230 are connected to network 300 via communication links 150 and 250 respectively. Typically Wi-Fi communication or cellular network communication like GSM, 3G or LTE are used as communication links 150 and 250 but any type of PAN, LAN or WAN networks may be used.

In an exemplary embodiment of the invention, additionally or alternatively, as an alternative to a direct short range pear to pear communication mean 330, communication between ad terminal 230 and ad terminal 130 is carried out using network 310 and communication links 150 and 250.

Potential buyer 210 may complete online purchasing of the desired ad product 120 using ad terminal 230 which communicate with the appropriate server 320. If a sale transaction had been performed, ad agent 110 is credited for the sale transaction and a commission for the sale or other benefits would be accounted for ad agent 110. Potential buyer 210 may also earn benefits, such as but not limited to discounts for promoting buying products through the system.

In typical scenario, Plurality of potential buyer element 200 coexists together. For the sake of clarity, in FIG. 1 only single potential buyer element 200 is presented.

In accordance with the current invention, the same person can act both as ad agent 110 and potential buyer 210. Similarly and typically, ad terminal 230 and ad terminal 130 are implemented in a single device that can perform both services associated with ad terminal 130 and ad terminal 230. In accordance to some embodiment of the invention, ad terminal 130 and ad terminal 230 are different devices. Additionally or alternatively, in accordance to some embodiment of the invention, ad terminal 130 and ad terminal 230 are the same device but with different application software.

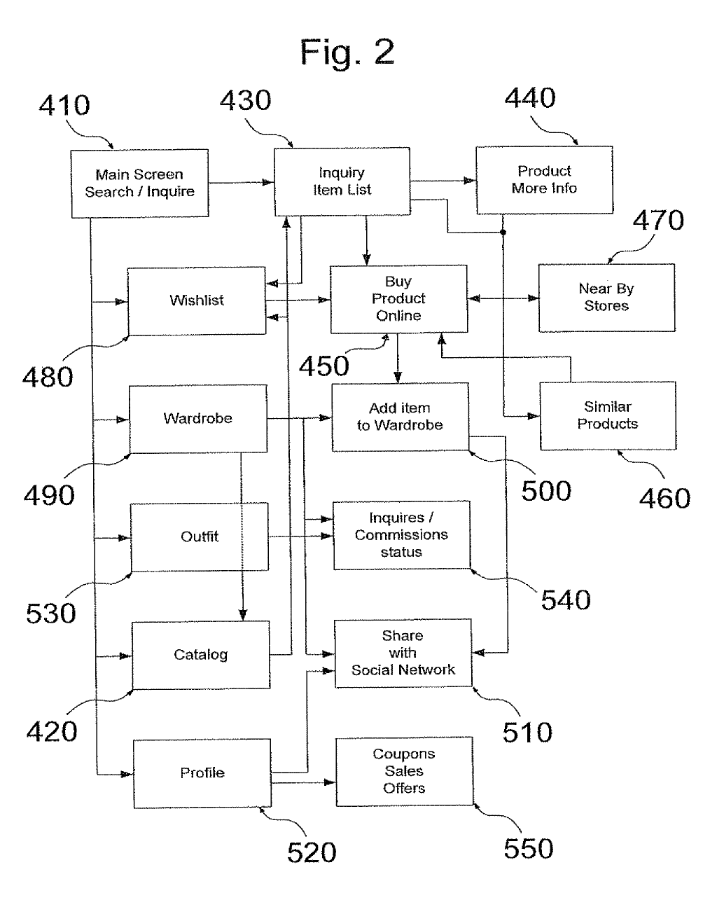

Reference is now made to FIGS. 2-18. FIGS. 2-18 illustrate exemplary software that implements some aspects of the invention on a smart phone. The exemplary software is focus on apparel. The concepts demonstrate the main is functionality that may be implemented in accordance with the invention and with a proper adaptation be used for any other consumer products segments.

Reference is now made to FIG. 2. FIG. 2 illustrates an exemplary block diagram of major software modules in accordance with the current invention. Software modules in this diagram are responsible, among other tasks, for the interaction with the user. Each software module presents one or more UI screens and performing the suitable tasks and functions according to the user interaction. More essential or frequent navigation and/or links between the modules/functions/UI screens are presented in FIG. 2. For the sake of clarity, less important links are omitted from FIG. 2 but such links as well as additional modules are optionally provided. Main module 410 is the initial code that runs when the application is activated. After performing all necessary setups and initializations, main module 410 displays the software main (home) screen.

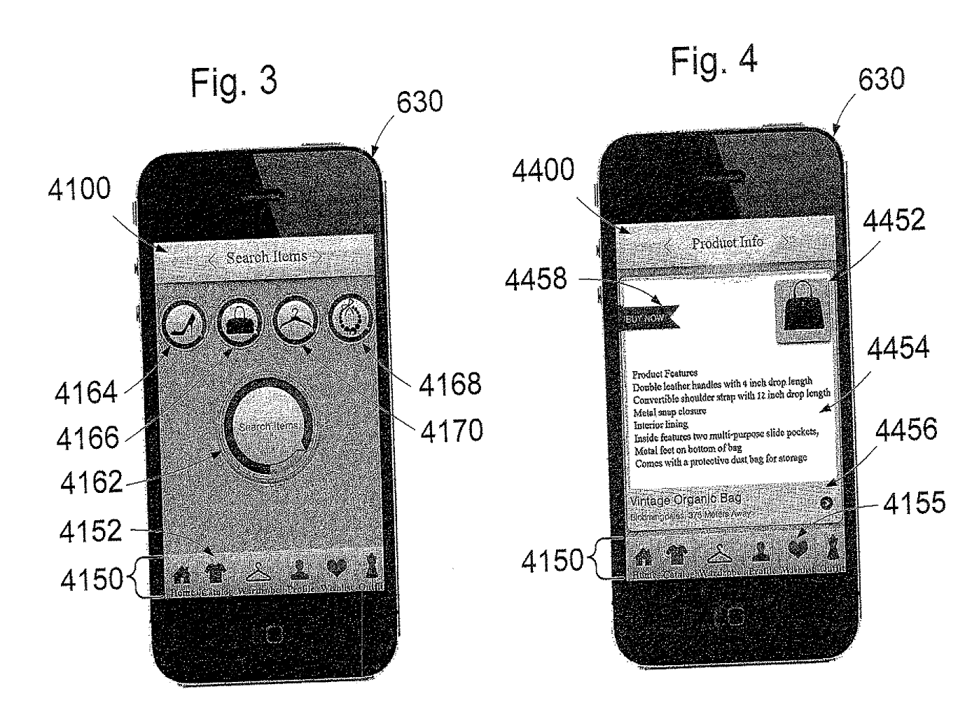

Reference is now made to FIG. 3. FIG. 3 illustrates the main screen of the ad terminal. Ad terminal 630 is implemented using a standard off-the-shelf smart phone running software application that implement both ad agent 110 and potential buyer 210 ad terminals 130 and 230 respectively. Home screen 4100 presents quick search keys to inquire for ad products a potential buyer sees in its proximity and is interested to get more info or buy. The user, i.e., potential buyer 210, can inquire all products around him by pressing button 2162 or search for specific major categories. To search for shoes user should press button 4164. To search for bags user should press button 4166. To search for clothes or jewelry and accessories user should press buttons 4168 and 4170 respectively. In home screen 4100, as well as all other UI screens, the top bar contains the title of the screen and the bottom bar contains main, menu 4150.

As used herein, the term “user” means a person that use the software and it can be taking the role of ad agent 110 or potential buyer 210 depending on the action being taken.

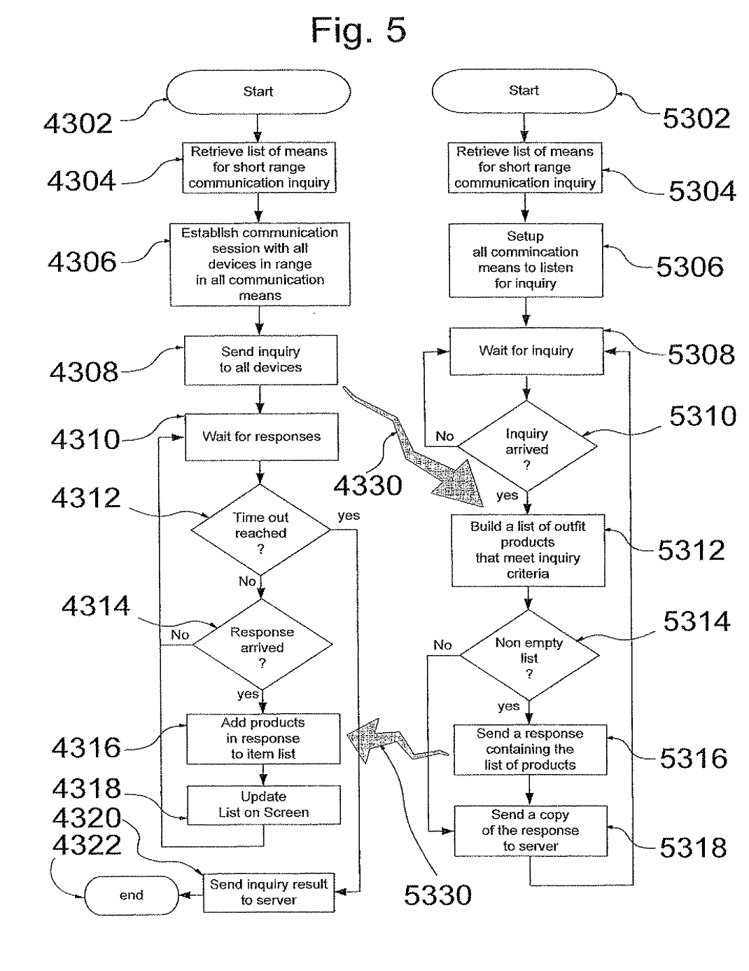

In response to inquiry, a list of items, i.e., ad products is presented to the user. The user can scroll and search the item list, but if the list is too long and the user wants to have shorter list in response to more specific inquiry she can search more specific by pressing the catalog button 4512 in the main menu 4510. More information on catalog functionality is provided hereinafter. An exemplary flowchart of the inquiry process is provided in FIG. 5.

Reference is now made back to FIG. 2. The outcome of an ad product inquiry is provided in ‘inquiry item list’ module/screen 430. The user may select an item in the list to seek for more information, module 440, immediately buy the product online, module 450, see similar products, module 460 or look for near by stores where the selected product is sold, module 470. If the user does not have the time to further process the item selection right away, she can add the item to the wishlist, module 480. An exemplary illustration for the wishlist screen is illustrated in FIG. 10. The user can enter wishlist 480, in a more convenient time, by pressing ‘wishlist’ button in the main menu.

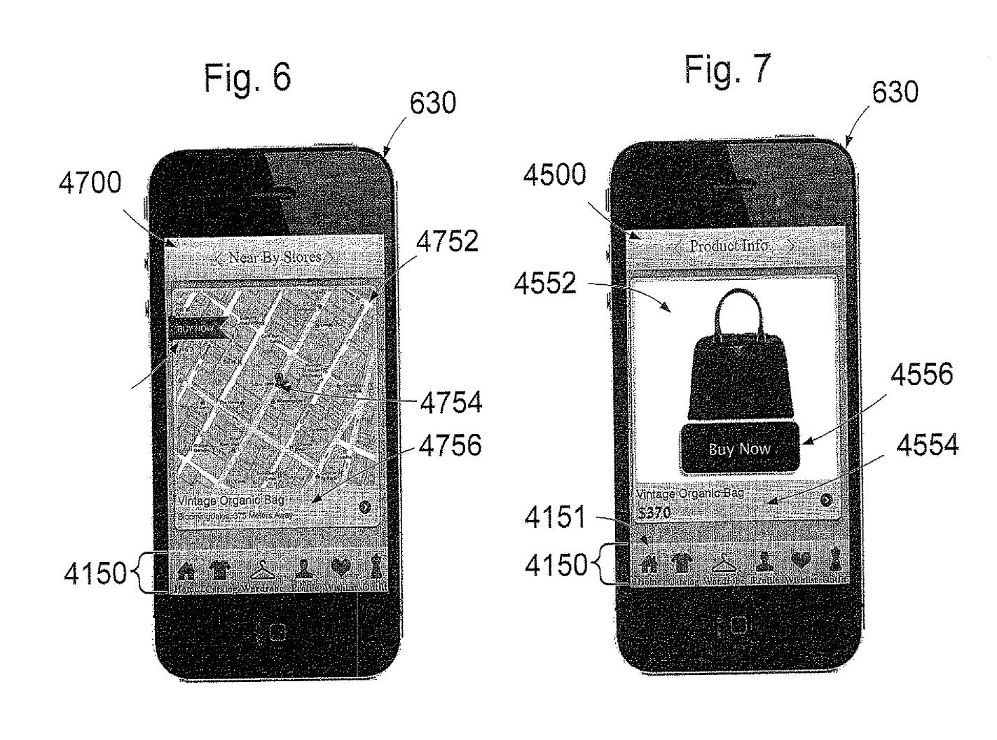

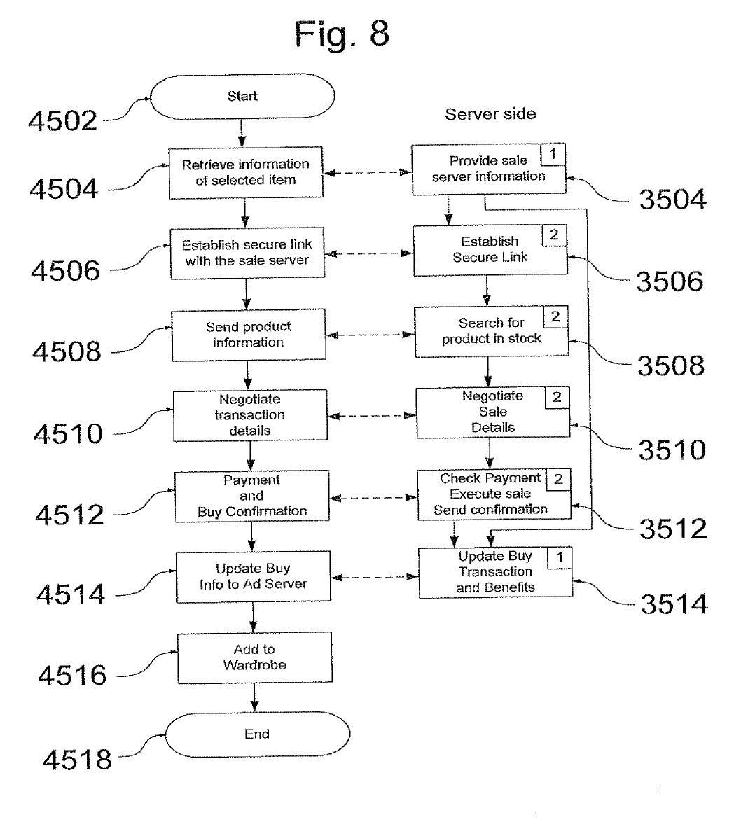

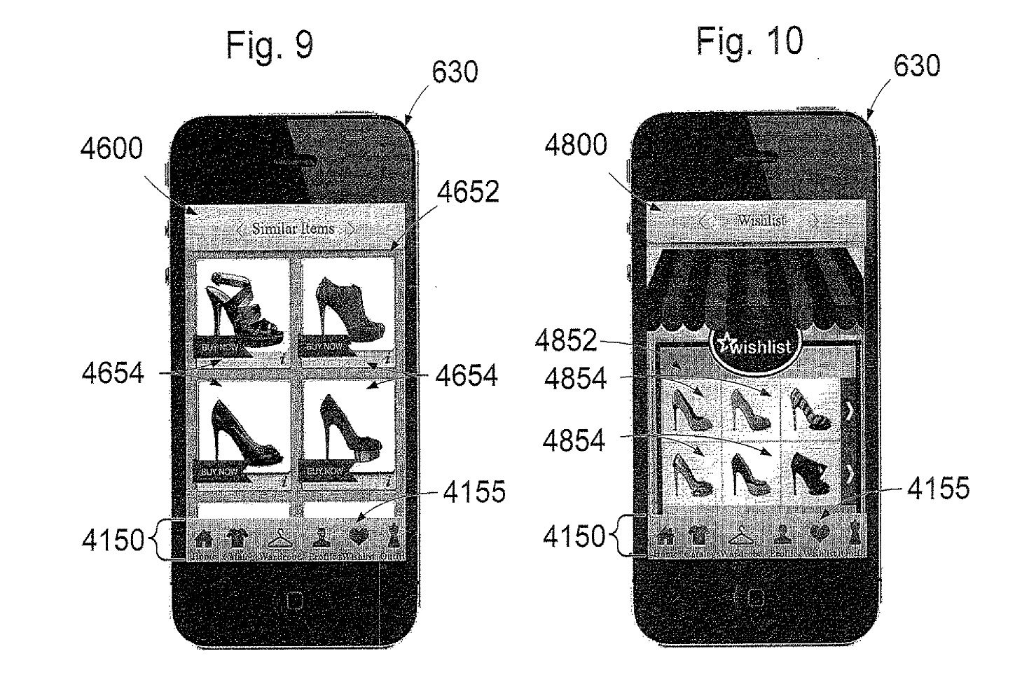

From wishlist 480 screen, user can access more information 440, seek for similar products 460 or look for near by stores 470 (for sake of figure celerity those links are not shown in the figure). In addition the user can select a product from wishlist module 480, or ‘buy product online’ module 450. An example of buy online module 450 screen is illustrated in FIG. 7. An exemplary buy online module 450 process flowchart is provided in FIG. 8. An exemplary of near by stores 450 screen is illustrated in FIG. 6. An exemplary of similar product 460 screen is illustrated in FIG. 9. From the main screen presented by module 410, user may enter wardrobe 490. Wardrobe 490 is the entire collection of items/products the user owns and manages using the software. The wardrobe metaphor was selected for the context of apparel but other metaphors such as storage, closet, cabinet or pantry may be used.

The term “wardrobe” means a list of all ad products 120 an ad agent 110 owns and manages for advertising in accordance with the current invention.

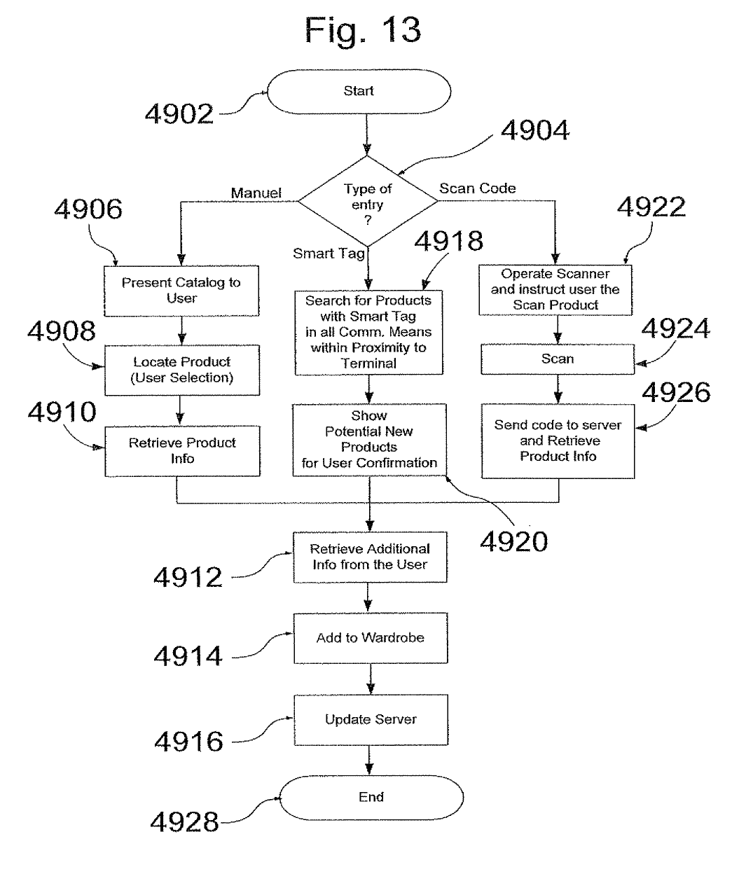

Products that bought online are automatically added to user wardrobe (executed by module ‘add item to wardrobe’ 500). In case item was not bought online, user can add the item manually or by scanning a bar code or a QR code or by reading a smart tag attached to the product. An exemplary ‘ad item to wardrobe’ 500 process flowchart is provided in FIG. 13. When item is entered manually, the user can use catalog 420 to search for the desired product. Item can be located by categories, manufacturer names and model numbers printed on the product label.

User may decide to share his entire wardrobe or specific items with his friends using a social network such as but not limited to Facebook, MySpace, Instagram, etc. Module 510, ‘share with social network’, manages the user interface and functions to do that. User can setup his social networks and his account details in profile 520.

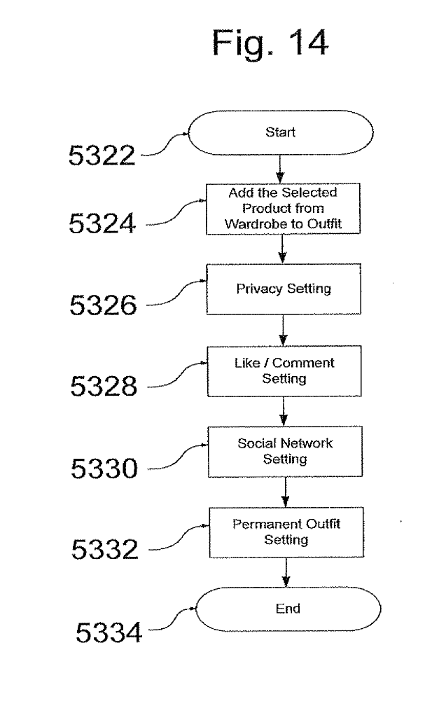

When a user is in public and wants to advertise ad products he need to activate and update his outfit, module 530. The outfit metaphor was selected in the context of apparel but other metaphors such as baggage, luggage, briefcase or suitcase may be used. An exemplary of adding item to outfit process flowchart executed by outfit module 530 is provided in FIG. 14.

The term “outfit” means a list of ad products currently worn, carried or used by ad agent and are proposed for advertising in accordance with the current invention.

Outfit UI screen in module 530 provides to the user the ability to start/end advertising and to select his outfit. Any ad product with RFID or smart tag may be updated in to the outfit automatically. Other items can be selected from the wardrobe and added to the current outfit. Optionally, user defines his home location and the program automatically, using GPS location services, enable and disable outfit advertising. In an exemplary embodiment of the invention, the user defines items in the wardrobe that will always appear in the outfit. User can define a privacy rules for the outfit. Outfit can be set to be anonymous so the potential buyer will not have any details on the ad agent other then the ad product information. Alternatively, outfit can be set to be public so the potential buyer may see ad agent details and optionally send messages or comments, e.g., make like, to the ad agent.

Profile module 520 provide UI functions and screens to manage the storage of verity of user information such as but not limited to preferred payment methods, user info such as name, gender, age, user picture, privacy settings, buying preference such as wearing size, favorite colors, favorite brands and models, favorite price range, etc.

Inquires/Commissions status' module 540 contains info screens in which the user can view information and statistics on the amount of commissions earned from advertising, discount already exploited, number of inquiry and interested users on the ad products etc. ‘Inquires/Commissions status’ screens 540 can be activated from outfit 530 to see user current, e.g., today, earning; or from wardrobe 490 to see specific item earning; or from profile, module 520, to see the entire info and statistics. An example of ‘Inquires/Commissions status’ 540 screen is provided in FIG. 18.

From profile module 520 screen, user can move to ‘Coupons/Sales/Offers’ module 550. Coupons/Sales/Offers module 550 manages the coupons, offers and sales promotion the user gets based on her activity on the system.

Reference is now made to FIG. 4. FIG. 4 illustrates an exemplary screen presented by ‘product more info’ module 440. Screen 4400 contains a title bar on top of the screen, the main menu bar 4150 on bottom of the screen, product image 4452, product feature list 4454 and additional information 4456 including, but not limited to, stores to buy, prices, sizes and colors, link to the manufacturer web site, etc. Pressing buy now button 4458 will transfer the user to buy product online screen provided by module 450. Dragging the icon to the wishlist button 4155 in main menu 4150 will add the product to the wishlist.

Reference is now made to FIG. 5. FIG. 5 illustrates an exemplary flowchart of the inquiry for ad products 120. The inquiry initiated by potential buyer 210. The flow starts in step 4302 once potential buyer 210, i.e., the user that is using ad terminal 630, selects inquiry button provided by main module 410. The flow is performed by ‘inquiry/item list’ module 430 that among other tasks is responsible to display a list of ad products based upon the user inquiry request. In the first step 4304, the program retrieves the list of means of short range communication used to contact near by ad terminals 130. In step 4306, the program establishes communication session with all the devices in the range in all the communication means. Optionally, if the communication mean do not need to establish a communication session prior to send the inquiry, this step is skipped for that mean of communication. Next, in step 4308, the program sends the inquiry to all near-by devices. In communication means that allows it, the inquiry is sent as a broadcast message to all near-by devices. In communication means that only peer to peer communication supported, each ad terminal 130 that a communication session was establish with, receive a private inquiry message. The inquiry messages 4330 send over the wireless media and received and processed by all near by ad terminal 130. The flowchart of processing the message will describe later on. The inquiry message may be non specific, i.e. inquiry of all ad product, or specific and focus on product categories such as shoes, bags, etc.

Next, the program waits in a loop for response 4310. The loop contains two checks: check for response to arrive 4314 and check for time out 4312. The response message 5330 is wirelessly transmitted from the ad agent 110 to the potential buyer 210 using short range wireless communication link 330. If a response arrives, the program, in step 4316 and 4318 processes the response message, which contains a list of ad products, adds them to the ‘in sight item list’ and displays the updated list to the user. When a time out is reached, in step 4320, the program sends a report of the inquiry event including but not limited to the ID and location of the inquiring device, the IDs and locations of the responding devices and information all the ad product results via network 310 to a server 320.

The flowchart ends in step 4322 and the program continue to run in module 430 that further displays the results to the user. In case no item had been found, a suitable message is presented to the user. In response, the user may broaden his inquiry. In case no active ad terminals 130 had been found, optionally, a different message is presented to the user.

The right side of FIG. 5 contains the flowchart of processing the response from ad terminal 130 to the inquiry of potential buyer 210. The specific flow chart starts 5302 when the user enables advertising of his outfit. This event is occurring while interacting with outfit module 530 (FIG. 12 illustrates the actual screen). In step 5304 and step 5306 the program retrieve and setup all communication means 330 that are used for short range communication between ad terminal 130 and 230. Then the program waits for inquiry. When inquiry message 4330 received, in step 5312 the program process the message, search for ad product that meet the inquiry and build a list of the products that meet the inquiry criteria. If the list is not empty (step 5314) the program send a response containing the list of products (step 5316) to the potential buyer 210 ad terminal 230. Optionally, a message stating no item was found is sent back in case of an empty list. Next, in step 5318, a report is sent to server 320. The report contains a copy of the response send to ad terminal 230 and optionally additional information such as but not limited to the ID and location of the sending ad terminal 130. The program stays in wait loop for as long as the outfit is active. When user deactivate outfit the program cease to wait and respond to inquiries (not shown in the flow chart). To avoid blocking, this flowchart (starting in step 5302) is running in independent thread.

In an exemplary embodiment of the invention, additionally or alternatively, communication 330 may be carried using network 310 and communication links 150 and 250. In this case, a server 320 is maintaining the communication between ad terminals 130 and 230. Server 320 tracks, for example using GPS reports from each ad terminal, the current location of the ad terminals. When specific ad terminal 230 send an inquiry to server 320 the server search all ad terminals 130 located in proximity to the inquiring ad terminal 230 and sends all ad terminals 130 the inquiry using network 310 and communication link 150. In turn, the terminals respond back with their responses to server 320 using network 310 and communication links 150 as well. Server 320 forwards the responses to the inquiring ad terminal 230 using network 310 and communication link 250. Optionally, Server 320 aggregate ad terminals 130 responses and send an aggregated response to ad terminals 130. Additionally or alternatively, Server 320 manage locally in the server a list of ad product 120 in each advertising unit 100 and send ad terminal 230 a response based on its local database without actually inquire ad terminals 130.

In an exemplary embodiment of the invention, additionally or alternatively, communication 330 may be carried through the smart tags. In this case, ad terminal 230 communicates directly with smart tag enabled ad product 120 using link 140. Optionally, an inquiry is done directly with ad product with out any intervention from ad terminal 130. Alternatively, smart tag enabled ad product 120 transfers the inquiry to Ad terminal 130 and ad terminal 130 response to ad product 120 through communication link 140 and ad product 120 transfers the response further to ad terminal 230 using communication link 140.

Reference is now made to FIG. 6. FIG. 6 illustrates an exemplary screen of module ‘near by stores’ 470. Screen 4700 contains a title bar and the main menu bar 4150. A map 4752 with a mark 4754 pointing the place of the closet store to buy the product is presented. Other information field 4756 contains information such as but not limited to the name of the store, its address, distance and walking or driving time, etc.

Reference is now made to FIG. 7. FIG. 7 illustrates an exemplary screen presented by ‘buy product online’ module 450. Screen 4500 contains a title bar in top of the screen, the main menu bar 4150 in bottom of the screen, product image 4552, and product name and price 4504. Pressing buy now button 4506 will start buy online process illustrated in FIG. 8. When the buy online process is finished, user may press home button 4151 in main menu 4150 to go back to home screen and start another inquiry.

Reference is now made to FIG. 8. FIG. 8 illustrates an exemplary flowchart of the buy online process. The buy online processing initiated by potential buyer 210 and carried out by ‘Buy Product Online’ module 450. The flow starts in step 4502 once the user selects to buy an ad product. The user can start buying ad product from a screen that show a selected ad product after inquiry or by using other screens or scenarios such as select item from the wish list, select item from the catalog or other screens provided by the software. The first step 4504 is to retrieve information on the selected product to buy. The information retrieved from a first server in step 3504. First server is the advertising server manages and aggregates the advertising activity performed by all ad agents 110. In the exemplary embodiment, the actual sale transaction is performed by a second server, the seller server. This server may be operated by other entity then the entity that operating advertising server. The entity that operates the seller server may include but is not limited to the product manufacture, distributors, retailers or wholesalers. The information on the selected product that send back by the advertising server contains the details of the seller server and additional information such as but not limited to the price of the product, the discount the potential buyer is entitled to, a coupon to execute the discount or coupons to other related products. The advertising server may direct the potential buyer to different seller servers based on various considerations. The considerations may include but are not limited to the geographical location of the user, the sale price, the amount of commission for the sale earned by the advertiser, etc.

In step 4506 the program establishes a secure link for the sale transaction with the seller server. Optionally, advertising server connects to the seller server to provide additional information. Alternatively, communication to selling server is done via advertising server and no direct connection between seller server and ad terminal is established. When the secure link for the sale transaction established, program (step 4508) send the requested product information to the seller server. Seller server checks the availability of the product in stock (step 3506 performed on the seller server) and if the product is available, programs in ad terminal and in seller server continue to negotiate the sale transaction in steps 4510 and 3510 (performed in ad terminal and seller server respectively). The negotiation may include but is not limited to product colors, product size, product options, product pickup method, delivery address, invoice details etc. Optionally, some of those details may be automatically provided by ad terminal program by retrieving the potential buyer information stored in her profile. When both sides are ready to complete the sale transaction, both side move to steps 4512 and 3512 performed in ad terminal and seller server respectively. In this step payment method is transferred from ad terminal to seller buyer.

Optionally payment method is automatically retrieved from user profile and transferred by the seller server. yet another option, is that the user as an account managed on the advertising server and the actual financial transfer is done between the advertising server entity and the seller server entity while the advertising server entity accumulated all financial transactions of the potential buyer and bill him periodically, e.g., monthly. When payment method confirmed in process 3512, the seller server continue to send a confirmation details and to take all actions needed deliver the product to the buyer. Upon receiving the confirmation ad terminal program continue to step 4514 wherein the buy confirmation info is transferred to the advertising server. The program in advertising server, step 3514, updates the buy transaction and credit the buy transaction to both the buyer 210 and the ad agent 110 that his advertisement initiated the buy transaction. Upon advertiser policy, ad agent 110 might get commission for the sale. Both buyer 210 and ad agent 110 related to this transaction may get additional benefits, such as, increasing their discounts in future buys, get a specific sale coupons related to this transaction, etc. Ad terminal program continues next to step 4514 and automatically add the product just bought into the user wardrobe. The program ends in step 4518 and return back to the calling module.

Reference is now made to FIG. 9. FIG. 9 illustrates an exemplary screen presented by ‘Similar Products’ module 460. Screen 4600 contains a title bar, main menu bar 4150, and a scrollable image array 4652 of products image 4654 contains each a similar product to the previously selected product.

The user can select a specific product on the screen to open more information screen for the product, press the buy now button to directly buy the selected product online or drag the product to the wishlist button 4155 in main menu 4150 to add the to product to wishlist.

Reference is now made to FIG. 10. FIG. 10 illustrates, an exemplary screen presented by wishlist module 480. Screen 4800 contains a title bar, the main menu bar 4150, and a scrolling image array 4852 of products image 4854 that are in the wishlist. The user can touch a specific product to buy the selected product online. The user can jump to the wishlist screen by pressing wishlist button 4155 in main menu 4150 from any UI screen.

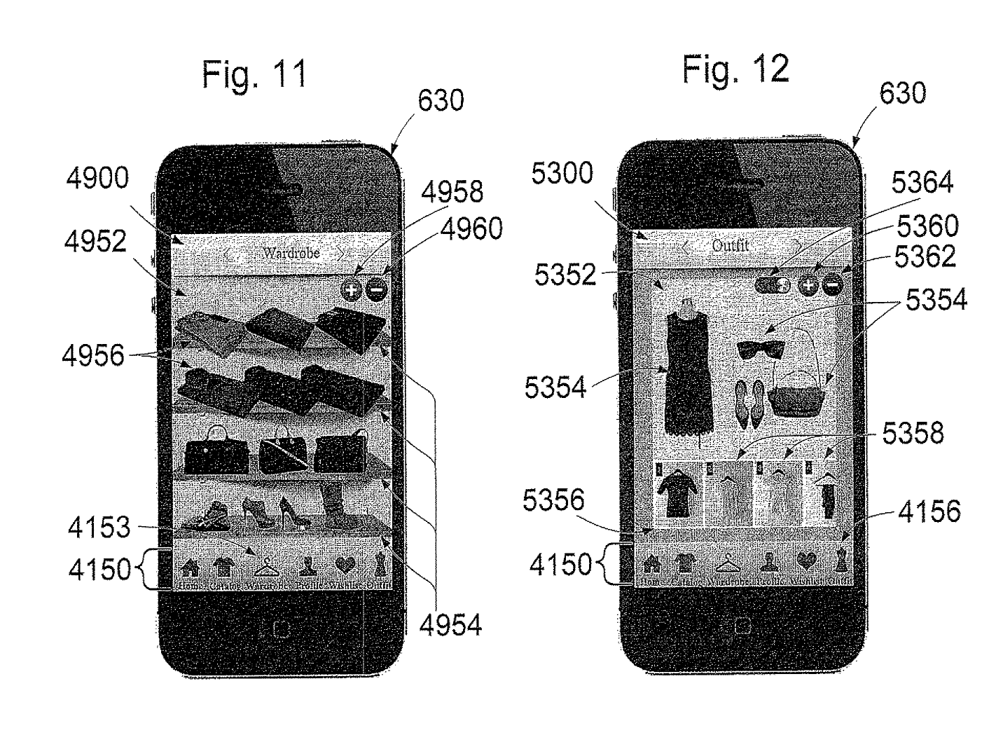

Reference is now made to FIG. 11. FIG. 11 illustrates an exemplary screen presented by wardrobe module 490. Screen 4900 contains a title bar, main menu bar 4150 and shelves 4954 in wardrobe 4952. Shelves 4954 contain images 4956 of the products in wardrobe 4952. The user can touch a specific product to see more info of the product such as when the product was bought, how much credits and commission was earned by the product, etc. To add a new product to wardrobe the user should press on button 4958. The flowchart of adding item to wardrobe is illustrated in FIG. 13. Button 4960 is used to remove item from wardrobe. The user can jump to this wardrobe screen by pressing wardrobe button 4153 in main menu 4150 from any screen.

Reference is now made to FIG. 13. FIG. 13 illustrates an exemplary flowchart of adding a product to the wardrobe. Adding an item to the wardrobe may be initiated automatically when buying an item online or manually by ad agent 110 by pressing button on wardrobe main screen (shown in FIG. 11). When the user initiate addition of an item to the wardrobe, the program execute step 4902. User selects the way to add items to wardrobe in step 4904. There are three ways to enter new item to wardrobe: (1) manually; (2) using smart tag; (3) using bar code.

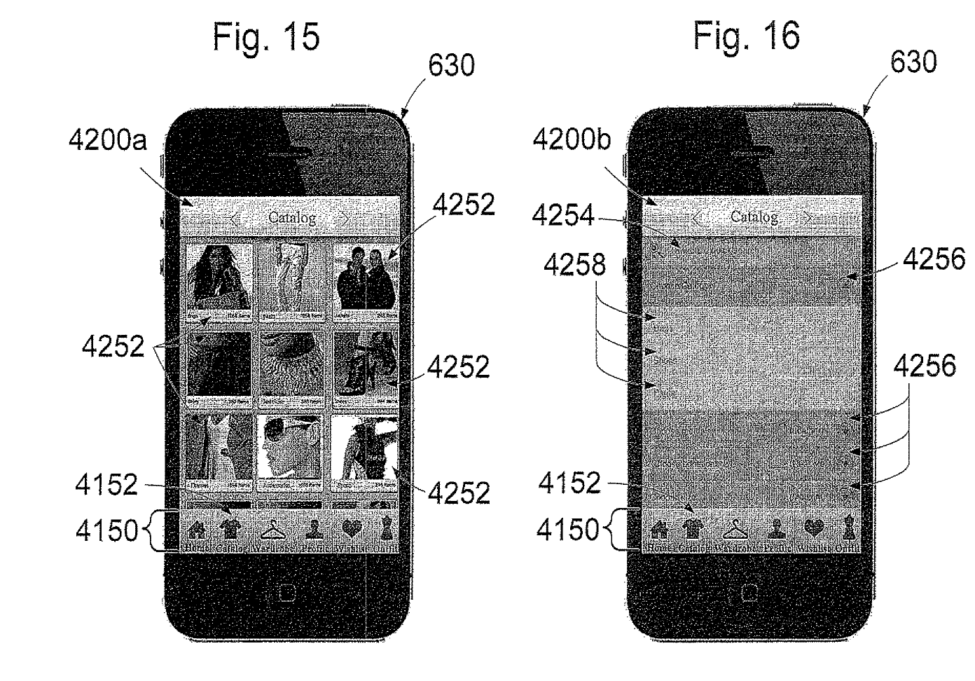

If manual item entry is selected, the program moves to step 4906. In this step the user is presented with the catalog of supported products. The screen presented to the user is similar to the screen illustrated in FIG. 15. In step 4908 the user interacts with the program to selects the right product he owns. There are several options to locate the specific product: (1) using a multi level catalog list; (2) using a search with the manufacturer name and/or the product model ID; (3) using a search for specific description and/or attribute. Optionally, other way to locate the item in the complete catalog may be used. Locating the product is done with the aid of a server via network 310. Pictures of the product are optionally presented to the user to help user to identification of the right product. When the product is selected by the user, the program moves to step 4910. In step 4910, the program retrieve the product information, including but not limited to, the name of the product, the image used to present it in the software, a unique system code used by the software for the product etc. Next, in step 4912, the program asks the user to enter additional information such as the place, e.g., the store, or the channel, e.g., the web site, the product had been bought in, the invoice number, a serial number printed on the product, product rating etc. This information, which is uploaded to the server, can be used by manufacturers and distributors to identify trends in sales and to cross check sale data to locate fake products sale in specific geographic areas or illegal trade of products in the distribution chain such as breach of exclusivity agreements or any other significant misconduct or any other events that effect the business.

When all necessary data on the product have been gathered, in step 1914 the product is actually added to the wardrobe database. Next, in step 4916, the program update the server with all the information and the server in its turn add the data to its database.

If smart tag item entry is selected, the program moves to step 4918. In this step the program search or inquire all smart tags within proximity to ad terminal 130 using all means of short range communication 140. Any product information retrieved from a compliant smart tag is first send to the server to retrieve the ad product information, including but not limited to, the name of the product, the image used to present it in the software, a unique system code that the software use for the product etc. The program searches the wardrobe to see if this product is not already in wardrobe. Any supported ad product that was not already in wardrobe is presented to the user in step 4920. The user selects the ad product he wants to enter the wardrobe and the program moves to step 4912. In steps 4912 to step 4916 additional information retrieved from the user, the product is added to wardrobe and server is updated in same manner as was described for manual product entry. Optionally, if a unique serial number of the ad product is stored in the smart tag, ad terminal 130 reads serial number info and sends it to the server. This info can be used to detect frauds.

If scan code item entry is selected, the program moves to step 4922. In this step the program activate the code scanner or camera to read the printed code. The program instructs the user how to scan the code. The user scans the code in step 4924. In step 4926, the scanned code is sent to the server, and the server in its turn converts the code to the actual product info and sends back the product info to the program. Any information imprinted on the code like product serial number is transferred to the server. Any frauds detection techniques like control number in the serial number will be send to the server and this information may be used to alert the proper entities. Next steps 4912-4916 are executed same as in manual and smart tag entry. Finally when all steps are executed the run is returned back to the calling module in final step 4928.

Reference is now made to FIG. 12. FIG. 12 illustrates an exemplary screen presented by outfit module 530. Screen 5300 contains a title bar, main menu bar 4150, a canvas 5352 of products image 5354 that are in the outfit and scrolling canvas 5356 of products image 5358 that are in the wardrobe. The user can drag and drop items from wardrobe canvas 5356 to outfit canvas 5352 to add items from wardrobe to outfit or drag and drop items from outfit canvas 5352 to wardrobe canvas 5356 to remove items from outfit back to wardrobe. Alternatively, the user can use button 5360 to add item to outfit and button 5362 to remove item from outfit. The process of adding item to outfit illustrated in FIG. 14. When outfit setup is complete swiping left button 5364 enable the outfit. Swiping right button 5364 disable the outfit.

User can jump to the outfit screen by pressing outfit button 4156 in main menu 4150 from any screen.

Reference is now made to FIG. 14. FIG. 14 illustrates an exemplary flowchart of adding a product to the outfit. Adding an item to the outfit is initiated by pressing button 5360 on outfit screen (shown in FIG. 12). Adding an item to the outfit starts in step 5322. First, in step 5324, the selected product is added to the outfit data structure. Next, in step 5326 the user set the privacy setting of the item. In case of anonymous item setting, only the item details will be provided to the potential buyer when inquiry is performed. In case of public item setting, the ad agent information will be provided as well. Next, the user can set if he wants to get likes or comments from potential buyers in step 5328. In step 5330, the user can decide if he wants to share with his social network his outfit as well as share the inquiries, the likes and the comments. Finally in step 5332 the user can set if the item or the current setting will be permanent on the outfit or will be temporary and removed from outfit once outfit will be disabled. Step 5334 end the outfit item addition process.

Reference is now made to FIG. 15. FIG. 15 illustrates an exemplary screen presented by catalog module 420. Screen 4200a contains a top title bar, main menu bar 4150 in the bottom of the screen and a scrolling array of categories 4252. When the user select the category she can make an inquiry for ad product in that category in her proximity, further navigate to subcategory select a specific product in the category and add it to her wishlist, look for near by stores or buy the product online. The user can jump to the category screen by pressing catalog button 4152 in main menu 4150 from any screen.

Reference is now made to FIG. 16. FIG. 16 illustrates alternative exemplary screen presented by catalog module 420. The user can switch between the screen presented in FIG. 15 and the screen presented in FIG. 16 by tapping on the catalog title or the catalog button 4152. Screen 4200b contains a top title bar, main menu bar 4150 in the bottom of the screen, a textual search field 4254 and a list of textual features and categories 4256 of products and sub-features or sub-categories 4258 of products. In quick textual search 4254 the user can enter any string, including but not limited to, category name, manufacturer name, model number, specific feature of product, etc. In feature/category search the user can easily scroll to see the features he is interested open sub-features or sub-categories to find the desired product.

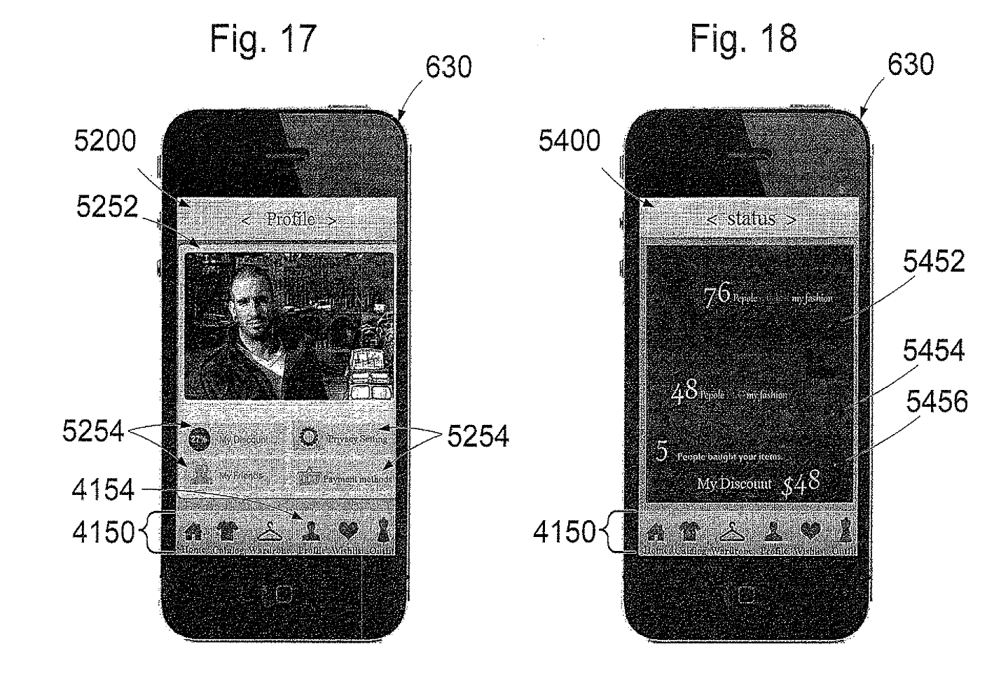

Reference is now made to FIG. 17. FIG. 17 illustrates an exemplary screen presented by profile module 520. Screen 5200 contains a top title bar, the main menu bar 4150 in the bottom of the screen, a profile picture 5252 and various buttons 5254. Using this screen the user can setup his profile data. The profile includes but is not limited to earned discount rates, privacy settings, friends and other social network settings, preferred payment methods, user info such as name, gender, age, buying preference such as wearing size, favorite colors, favorite brands and models, favorite price range, etc. The user can jump to the profile screen by pressing profile button 4154 in main menu 4150 from any screen.

Reference is now made to FIG. 18. FIG. 18 illustrates an exemplary screen presented by ‘Inquires/Commissions Status’ module 540. Screen 5400 contains a top title bar, main menu bar 4150 in the bottom of the screen, an inquiry status 5452, a comments/likes status 5454 and commission status 5256. Those status messages can be for specific time duration, e.g., day, week, month or total accumulated from the start of use. Additionally or alternatively, other statistics and status messages including but not limited to earned discount and wardrobe value are provided.

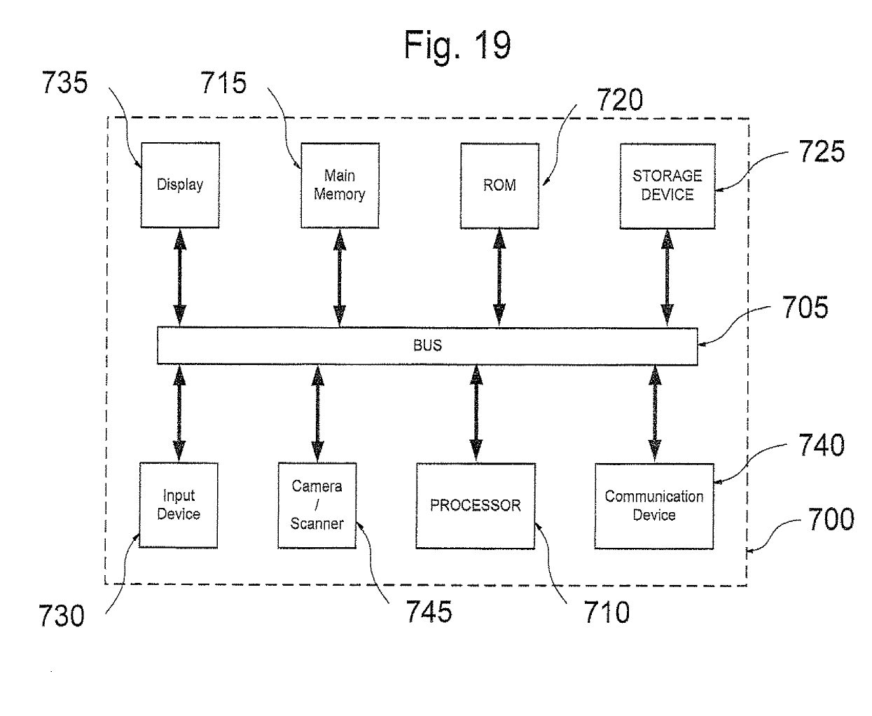

Reference is now made to FIG. 19. FIG. 19 illustrates an exemplary block diagram of computing system which may be used in accordance with an illustrative implementation of the current invention. Computing system 700 may be used to implement ad terminals 130, 230 and 630. Computing system 700 includes a bus 705 or other communication component for communicating information and a processor computing system 710 or processing circuit coupled to bus 705 for processing information. Computing system 700 may also include one or more processors 710 or processing circuits coupled to bus 705 for processing information. Computing system 700 also includes main memory 715, such as a random access memory (RAM) or other dynamic storage device, coupled to bus 705 for storing information, and instructions to be executed by processor 710. Main memory 715 may also be used for storing position information, temporary variables, or other intermediate information during execution of instructions by processor 710. Computing system 700 may further include a read-only memory (ROM) 720 or other static storage device coupled to bus 705 and configured to store static information and instructions for processor 710. A storage device 725, such as a solid state device, magnetic disk or optical disk, is coupled to bus 705 for persistently storing information and instructions.

Computing system 700 may be coupled via bus 705 to a display 735, such as a liquid crystal display, or active matrix display, for displaying information to a user. An input device 730, such as a keyboard, may be coupled to bus 705 and configured to communicate information and command selections to processor 710. In another implementation, input device 730 has a touch screen display 735. Input device 730 may include a cursor control, such as a mouse, a trackball, or cursor direction keys, for communicating direction information and command selections to processor 710 and for controlling cursor movement on display 735.

Computing system 700 may be coupled via bus 705 to one or more communication device 735, such as a Wi-Fi, GSM or NFC communication device, for communication between ad terminals (link 330), with smart tags (link 140) and with the network (links 150 and 250) as illustrated in FIG. 1.

Computing system 700 may be coupled via bus 705 to a camera or other optical scanning device 745 for reading tags and labels imprinted on ad products.

According to various implementations, the processes described herein may be implemented by computing system 700 in response to the processor 710 executing an arrangement of instructions contained in main memory 715. Such instructions may be read into main memory 715 from another computer-readable medium, such as the storage device 725. Execution of the arrangement of instructions contained in main memory 715 causes computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to effect illustrative implementations. Thus, implementations are not limited to any specific combination of hardware circuitry and software.

Although an example computing system has been described in FIG. 19, implementations described in this specification may be implemented in other types of digital electronic circuitry, or in computer software, firmware, or hardware, including the structures disclosed in this specification and their structural equivalents, or in combinations of one or more of them.

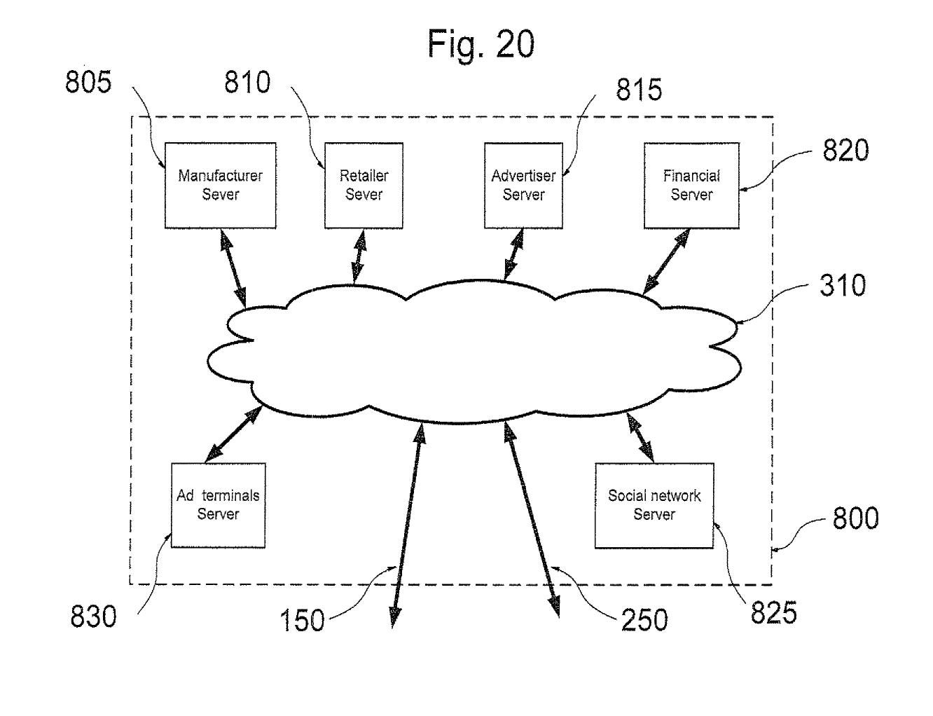

As used herein, the term “back office” means the collection of servers 320 together with the ad terminals, ad agents, ad products and potential buyers provide the full system solution in accordance to the current invention. The back office may be one server that is controlled by a single entity or it can be plurality of identical servers, i.e., server farm, running similar software to coupe with service load. Server farm can be dedicated to the system or part of hosting facility or cloud computing services. Alternatively, the back office implementation may be distributed between plurality of entities each responsible for part of the back office functionality. FIG. 20 illustrate an exemplary distributed back office in accordance with the current invention.

Reference is now made to FIG. 20. FIG. 20 illustrates an exemplary block diagram of the back office which may be used in accordance with an illustrative implementation of the current invention. Back office 800 contains plurality of servers 320 connected to a network 310, e.g., the internet. Severs may be managed by same entity or different entities. Any server in back office 800 may be coupled via the network 310 and communication links 150 and 250 to any ad terminal in the system.

Back office 800 may include one or more ad terminals sewer 830 coupled to network 310 for serving the core functionality of the system. Such functions include but are not limited to allocating, connecting or refereeing ad terminals to servers in back office 800, providing software updates to ad terminal, manage central database of the ad terminals that exist in the system and optionally databases for the wardrobes, outfits and inquires performed in the system. Typically, the entity that manages those servers will be the ad terminal software developer or the hardware developer or an ad terminal operator.

Back office 800 may include one or more manufacturer server 805 coupled to network 310 for providing catalog services, discounts, coupons and other services related to ad products manufacturers. Typically, the entity that manages those servers will be a manufacturer how have products advertised by the system.

Back office 800 may also include one or more retailer server 810 coupled to network 310 for providing near by stores services, discount services, coupons and any other services related to the chain of sale.

Back office 800 may also include one or more advertiser server 815 coupled to network 310 for providing coupon services and any other services related to the advertising agents/industry.

Back office 800 may also include one or more financial server 820 coupled to network 310 for providing financial transaction support, account management and any other services related to finance.

Back office 800 may also include one or more social network server 825 coupled to network 310 for providing social interaction services such as posting the wardrobe and outfit, getting comments and likes and any other services related to social interactions.

Back office 800 provides to the entities constructing the back office, and optionally, to other entities as a paid service, data mining services. Data mining services may include but are not limited to geographic distribution of product inquiry, popularity analysis of products segmented to age, gender, etc. A tight control of where products were bought and used may be gathered. This data provides important information to companies. For example it can indentify frauds and illegal sale conducts. Data mining may also include identifying ad agents that are opinion leaders. By locating those individuals, one can promote opinion leaders to use specific products by giving them products with major discount or free products. Data mining can be used to provide targeted ads and coupons based on user's preference. Data mining can identify trends in time as well as geographic trends, optionally segmented by age and gender.

Although an example of back office system has been described in FIG. 20, implementations described in this specification may be implemented in other types of software architectures, or in other types of computer architectures, including the structures disclosed in this specification and their structural equivalents, or in different partitioning and different combinations of one or more of them.

In general, Implementations described in this specification may be implemented in digital electronic circuitry, or in computer software, firmware, or hardware, including the structures disclosed in this specification and their structural equivalents, or in combinations of one or more of them. The implementations described in this specification may be implemented as one or more computer programs, i.e., one or more modules of computer program instructions, encoded on one or more computer storage media for execution by, or to control the operation of, data processing apparatus. Alternatively or in addition, the program instructions may be encoded on an artificially generated propagated signal, e.g., a machine-generated electrical, optical, or electromagnetic signal that is generated to encode information for transmission to suitable receiver apparatus for execution by a data processing apparatus.

The term “computing device” or “data processing apparatus” encompasses all kinds of apparatus, devices, and machines for processing data, including by way of example a programmable processor, a computer, a system on a chip, or multiple ones, or combinations of the foregoing. The apparatus may include special purpose logic circuitry, e.g., an FPGA (field programmable gate array) or an ASIC (application specific integrated circuit). The apparatus may also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing and grid computing infrastructures.

A computer program (also known as a program, software, software application, script, or code) may be written in any form of programming language, including compiled or interpreted languages, declarative or procedural languages, and it may be deployed in any form, including as a stand alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (FDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

While this specification contains many specific implementation details, these should not be construed as limitations on the scope of any inventions or of what may be claimed, but rather as descriptions of features specific to particular implementations of particular inventions. Certain features described in this specification in the context of separate implementations may also be implemented in combination in a single implementation. Conversely, various features described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated in a single software product or packaged into multiple software products.

Thus, particular implementations of the invention have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The use of flowchart diagrams is not meant to be limiting with respect to the order of operations performed. The herein described subject matter sometimes illustrates different components contained within, or connected with, different other components. It is to be understood that such depicted architectures are merely illustrative, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the is desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is expected that during the life of a patent maturing from this application many relevant technologies will be developed and the scope of the terms used is intended to include all such new technologies a priori.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method for advertising and sales of ad products carried or used by an ad agent comprising:
(a) associating tangible ad products to a first electronic device which is carried by said ad agent;
(b) receiving inquiries about said ad products from a second electronic device carried by a potential buyer who sees said ad products being worn, carried or used by said ad agent;
(c) responding by the first electronic device to said inquiry by sending a list of said ad products; and
(d) receiving said list by said second electronic device.

2. The method of claim 1, wherein said ad products are consumer products including shoes, clothes, bags, apparel, jackets, watches, glasses, purses, luggage cases, accessories, electric gadgets, mp3 players, cellular phones, tablets, laptops or any other commercial products used by said ad agent.

3. The method of claim 1, wherein said first electronic device and said second electronic device are off-the-shelf smart phones comprising an add-on application to manage said list of ad products and perform and process said inquiries.

4. The method of claim 1, wherein said ad products comprise smart tags which communicate with said first electronic device.

5. The method of claim 4, wherein the communication protocol between said smart tags and said first electronic devices is RFID or Bluetooth or ZigBee or NFC or WiFi or any other short range communication protocol.

6. The method of claim 1, wherein said first electronic device and said second electronic device are communicating with a server residing on a network.

7. The method of claim 6, wherein the communication protocol between said first and second electronic devices and said servers is Wi-Fi or 3G or LTE or any other communication protocol that is used to connect mobile devices to the Internet.

8. The method of claim 6, wherein said server comprises a plurality of servers.

9. The method of claim 6, wherein said server receives and stores information on the inquiries and responses of said first and second electronic devices.

10. The method of claim 6, wherein said server receives on-line purchasing requests of said ad products from said second electronic devices.

11. The method of claim 1, wherein said inquiry is performed using Wi-Fi, Bluetooth, RFID, ZigBee, NFC or any other short range communication protocol.

12. The method of claim 6, wherein said server receives the location information of said first and second electronic devices.

13. The method of claim 12, wherein said inquiry transaction between first and second electronic devices is performed indirectly using mediation by said server.

14. The method of claim 9, wherein said inquiries information stored by said server is further processed to detect fake products, frauds and other illegal acts or sales of ad products.

15. The method of claim 10, wherein said ad agent receives commissions for sale transactions related to responses to inquiries of ad products used by said ad agent.

16. The method of claim 1, wherein said ad agents and said potential buyers receive discounts, commissions and other benefits for performing said inquires and providing said responses.

17. An advertising and sales system comprising:
(a) plurality of ad terminals configured to be used and carried by ad agents, wherein ad agents are persons wearing, carrying or using tangible ad products;
(b) plurality of ad terminals configured to be used and carried by potential buyers, wherein potential buyers are persons who sees ad products worn, carried or used by said ad agents and interested on buying said ad products; and
(c) one or more servers;
wherein said ad terminals that are carried by potential buyers are configured to inquire said ad terminals which is carried by ad agents and are located within proximity of said potential buyers, and wherein said ad terminals that are carried by ad agents are configured to respond to said inquiries with a list of ad products worn, carried or used by said ad agents, and wherein said server records information on said inquires and responses and provide purchasing services for said ad products on said list.

18. The system of claim 17, wherein said ad terminals are off-the-shelf smart phones comprising an add-on application.

19. The system of claim 17, wherein said ad products comprise smart tags which communicate with said ad terminals.

20. The system of claim 19, wherein said inquiry is performed directly between ad terminals carried by potential buyers and said smart tags.

21. The system of claim 17, wherein said inquiries and responses information recorded by the server is further processed to detect fake products, frauds and other illegal acts or sales of ad products.

22. A personal mobile device carried by ad agent for product advertisement comprising:
(a) a storage containing a list of tangible ad products;
(b) a communication means configured to receive inquiries and to send responses on said ad product list;
(c) a processor to process said inquiries and compose said responses;
wherein the inquiries is initiated by potential ad product buyers who sees the ad products in use and said response contains an advertising information to promote said ad product purchasing.

23. A non-transitory computer-readable medium carrying one or more sequences of instructions, configured to implement:
(a) a wardrobe, wherein a wardrobe is a list of tangible ad products ad agent has possession of;
(b) an outfit, wherein an outfit is a list of ad products from the wardrobe ad agent instantaneously caring on;
(c) an inquiry service that enables a user who is a potential buyer to inquire for ad products in said outfits in proximity to said user;
(d) an response service that respond to said inquiries with ad information on said outfit.

24. The non-transitory computer-readable medium of claim 23, wherein said sequence of instructions is executed on a smartphone.

25. The non-transitory computer-readable medium of claim 24, wherein said software further comprises service that enable online purchasing of ad products appears in said response to said inquiry.
